(19) United States
(12) Patent Application Publication
(10) Pub. No.: US 2007/0280678 A1
(43) Pub. Date: Dec. 6, 2007

(54) CAMERA MODULE AND FABRICATING METHOD THEREOF

(76) Inventors: Chin-Huan Chien, Miao- Li Hsien (TW); Chih-Hsiung Su, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/566,674

(22) Filed: Dec. 4, 2006

(30) Foreign Application Priority Data
May 30, 2006 (TW) 095119189

(51) Int. Cl. G03B 17/00

(52) U.S. Cl. 396/529

(57) ABSTRACT

Camera modules and fabricating methods thereof are provided. A camera module includes a lens set, a holder, and a sensor module. The holder has a housing and a base part. The housing has an opening. The lens set is disposed in the housing. External light outside the housing can arrive at the lens set through the opening. The housing and the base part are integral. The sensor module is connected to the base part.

### BACKGROUND OF THE INVENTION

1. Field of the Invention

The present invention relates to a camera module and fabricating method thereof, and more particularly, to a digital camera module and fabricating method thereof.

2. Description of the Prior Art

Please refer to FIG. 1. FIG. 1 is an explosive view of a camera module 10 of the prior art. As shown in FIG. 1, the camera module 10 comprises a lens barrel 12, a holder 14, and a sensor module 16. A lens set (not shown) is disposed in the lens barrel 12. The lens barrel 12 has screw threads at its exterior surface for engaging the lens barrel 12 with the holder 14. Components of the sensor module 16 may vary as the corresponding manufacturing technology varies. The manufacturing technology of the sensor module 16 can be categorized into two kinds: chip scale package (CSP) manufacturing technology and chip on board (COB) manufacturing technology. The embodiment shown in FIG. 1 is achieved through CSP manufacturing technology. Therefore, the sensor module 16 comprises a sensor chip 22, a flexible printed circuit board (FPCB) 24, an adhesive 26, and a stainless steel sheet 28.

To assemble the camera module 10, the lens set must be disposed in the lens barrel 12, and the sensor chip 22 mounted on the FPCB 24. Then, the FPCB 24 is fixed to the stainless steel sheet 28 by the adhesive 26, thus completing the sensor module 16. Further, the sensor module 16 is fixed to a bottom of the holder 14 by an adhesive material. Finally, the lens barrel 12 is screwed into the holder 14. The lens barrel 12 has screw threads at its exterior surface, and the holder 14 has corresponding screw threads at its interior surface. Therefore, a number of complete turns used to screw the lens barrel 12 into the holder 14 can determine a distance between the lens barrel 12 and the sensor module 16 to further adjust a focal distance of the camera module 10. Thus, when light arrives at the sensor chip 22 through the lens set, the sensor chip 22 will transfer a detected image to a back-end processing circuit through the FPCB 24.

There are some drawbacks related to the camera module 10. For example, when the lens barrel 12 is screwed into the holder 14, an improper force can cause the lens barrel 12 to tilt, and thus a light axis of the camera module 10 is deviated. Moreover, when the lens barrel 12 is screwed into the holder 14, friction between the screw threads of the lens barrel 12 and the holder 14 may cause dropped particles, which further affect image quality of the sensor chip 22. These drawbacks greatly decrease yield rates and increase production costs of the camera module 10.

### SUMMARY OF THE INVENTION

It is therefore one of the objectives of the present invention to provide a camera module and fabricating method thereof to solve the above mentioned problems.

The present invention provides a camera module, comprising: a lens set; a holder, comprising: a housing, having an opening, wherein the lens set is disposed in the housing, and external light outside the housing can arrive at the lens set through the opening; and a base part, wherein the housing and the base part are integral; and a sensor module, connected to the base part.

The present invention further provides a method for fabricating camera modules, comprising: utilizing a mold to make a holder with injection molding technology, wherein the holder comprises a housing and a base part; disposing a lens set in the housing; and connecting a sensor module to the base part; wherein the housing has an opening, and external light outside the housing can arrive at the lens set through the opening.

Because the housing and the base part are integral in some embodiments of the present invention, the housing and the base part do not need to be assembled utilizing an engaging structure such as screw threads, thereby avoiding the dropped particles caused by friction between the lens barrel and the holder of the prior art. Further, the assembling process is simplified, and the yield rate thereby is increased greatly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an explosive view of a camera module of the prior art.

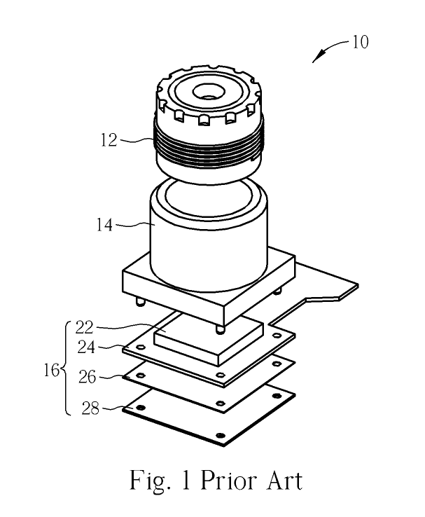

FIG. 2 is an explosive view of a camera module according to a first embodiment of the present invention.

FIG. 3 is an exterior view of the camera module in FIG. 2 after assemblage

FIG. 4 is an explosive view of a camera module according to a second embodiment of the present invention.

FIG. 5 is an exterior view of the camera module in FIG. 4 after assemblage.

### DETAILED DESCRIPTION

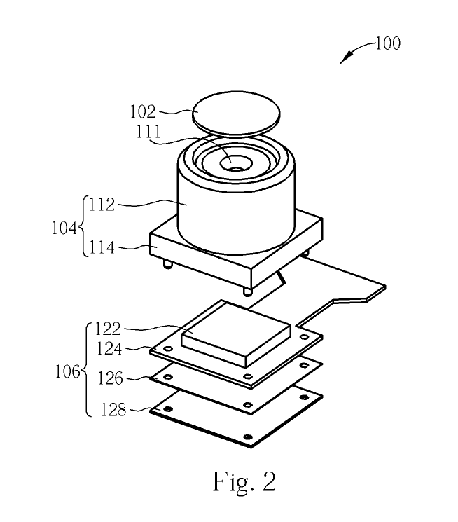

Please refer to FIG. 2. FIG. 2 is an explosive view of a camera module 100 according to a first embodiment of the present invention. The camera module 100 comprises a lens set 102, a holder 104, and a sensor module 106. The lens set 102 in this embodiment only includes one lens, but the number of lenses can be modified in other embodiments if needed. In other words, the lens set 102 can have a plurality of lenses. The holder 104 comprises a housing 112 and a base part 114. The lens set 102 is disposed in the housing 112. The housing 112 has an opening 111 on its top. External light outside the housing 112 can arrive at the lens set 102 through the opening 111. The function of the housing 112 herein is similar to that of the lens barrel of the prior art. Moreover, the housing 112 and the base part 114 are integral. The holder 104 comprising the housing 112 and the base part 114 is made through injection molding technology utilizing a mold. The prior art lens barrel and holder, however, must be assembled after being made separately through injection molding technology.

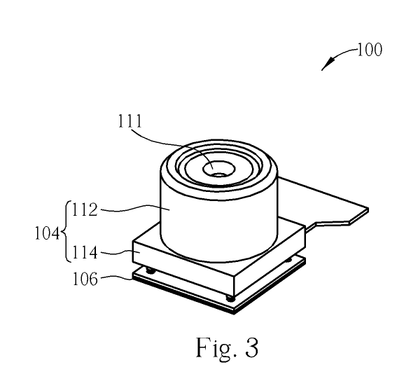

In this embodiment, the sensor module 106 is achieved through CSP manufacturing technology. Therefore, the sensor module 106 comprises a sensor chip 122, a flexible printed circuit board (FPCB) 124, an adhesive 126, and a stainless steel sheet 128. The method of assembling the sensor module 106 is well known in the art and is thus omitted here for simplicity. Please note that the housing 112 and the base part 114 are hollow. To manufacture the camera module 100, the holder 104 must be made first through injection molding technology utilizing a mold, and then the lens set 102 is inserted into and fixed in the housing 112 through the base part 114. The sensor module 106 is assembled and a distance between the holder 104 and the sensor module 106 is then calibrated. Finally, an adhesive material is injected between the base part 114 of the holder 104 and the sensor module 106 to maintain the distance between the holder 104 and the sensor module 106. Please refer to FIG. 3. FIG. 3 is an exterior view of the camera module 100 after assembled.

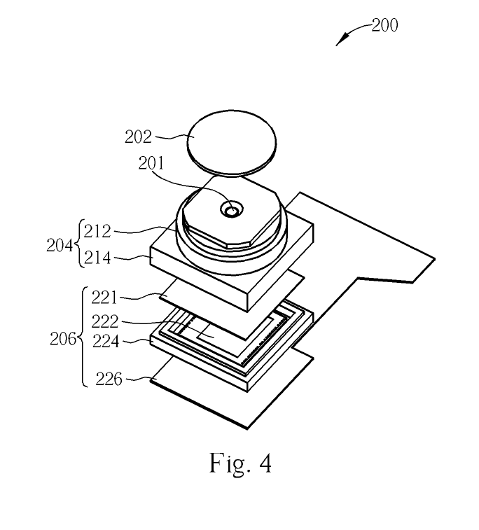

Please refer to FIG. 4. FIG. 4 is an explosive view of a camera module 200 according to a second embodiment of the present invention. The camera module 200 comprises a lens set 202, a holder 204, and a sensor module 206. The holder 204 comprises a housing 212 and a base part 214. The housing 212 has an opening 201 on its top. In this embodiment, the sensor module 206 is achieved through COB manufacturing technology. Therefore, the sensor module 206 comprises a light filtering sheet 221, a sensor chip 222, a printed circuit board (PCB) 224, and a FPCB 226. To assemble the sensor module 206, the sensor chip 222 must be fixedly connected to the PCB 224 first in a wire-bonding manner, and the PCB 224 then connected to the FPCB 226. The method of assembling the sensor module 206 through COB manufacturing technology is well known in the art and is thus omitted here for simplicity.

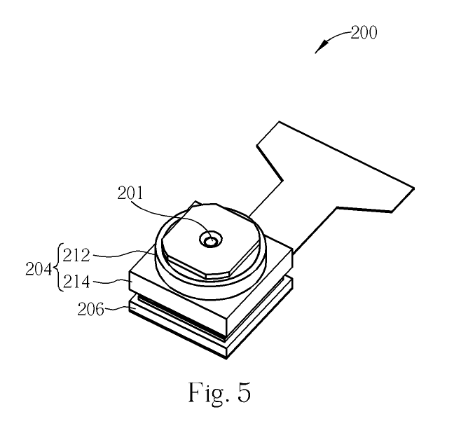

Similar to the first embodiment, to manufacture the camera module 200, the holder 204 must be made first through injection molding technology utilizing a mold, and the lens set 202 then inserted into the housing 212 through the base part 214. The sensor module 206 is assembled and a distance between the holder 204 and the sensor module 206 is then calibrated. Finally, an adhesive material is injected between the holder 204 and the assembled sensor module 206 to maintain the distance between the holder 204 and the sensor module 206. Please refer to FIG. 5. FIG. 5 is an exterior view of the camera module 200 after assemblage.

Because the housing of the holder and the base part are integral in some embodiments of the present invention, the prior art assembly step of screwing the lens barrel into the holder can be saved, therefore avoiding a deviated light axis caused by an improper force applied on the lens barrel, and further avoiding dropped particles caused by friction between the lens barrel and the holder. Moreover, the housing and the base part are integral, so the assembling inaccuracy can be avoided, the strength of the housing and the base part as a whole can be enhanced, and the production costs can be decreased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A camera module, comprising:
a lens set;
a holder, comprising:
a housing, having an opening, wherein the lens set is disposed in the housing, and external light outside the housing can arrive at the lens set through the opening; and
a base part, wherein the housing and the base part are integral; and
a sensor module, connected to the base part.

2. The camera module of claim 1, wherein the sensor module comprises:
a bottom base, fixedly connected to a bottom of the base part;
a flexible printed circuit board (FPCB), fixedly disposed on the bottom base; and
a sensor chip, fixedly disposed on the FPCB.

3. The camera module of claim 1, wherein the sensor module comprises:
a sensor chip;
a printed circuit board (PCB), fixedly connected to the base part, wherein the sensor chip is fixedly connected to the PCB in a wire-bonding manner; and
a flexible printed circuit board (FPCB), connected to the PCB.

4. A method for fabricating camera modules, comprising:
making a holder through injection molding technology utilizing a mold, wherein the holder comprises a housing and a base part;
disposing a lens set in the housing; and
connecting a sensor module to the base part;
wherein the housing has an opening, and external light outside the housing can arrive at the lens set through the opening.

5. The method of claim 4, wherein the step of disposing the lens set comprises:
disposing the lens set in the housing through the base part.

6. The method of claim 4, wherein the step of connecting the sensor module to the base part comprises:
calibrating a distance between the holder and the sensor module to accomplish focus; and
injecting an adhesive material between the base part and the sensor module to maintain the distance between the holder and the sensor module after the distance between the holder and the sensor module has been calibrated.

7. A camera module, comprising:
a base plate;
a holder, disposed on the base plate, wherein the holder comprises:
a housing, having an opening, wherein external light outside the housing can travel into the housing through the opening; and
a base part, disposed on the base plate, wherein the housing and the base part are integral;
at least a lens, disposed the housing correspondingly to the opening; and
a sensor chip, below the lens and disposed on the base plate for detecting the external light traveling into the housing.
